(19) United States
(12) Patent Application Publication
(10) Pub. No.: US 2011/0199273 A1
(43) Pub. Date: Aug. 18, 2011

(54) PLANAR META-MATERIAL HAVING NEGATIVE PERMITTIVITY, NEGATIVE PERMEABILITY, AND NEGATIVE REFRACTIVE INDEX, PLANAR META-MATERIAL STRUCTURE INCLUDING THE PLANAR META-MATERIAL, AND ANTENNA SYSTEM INCLUDING THE PLANAR META-MATERIAL STRUCTURE

(75) Inventors: Dongho Kim, Daejeon-city (KR); Jeongho Ju, Seoul (KR); Jae-Ick Choi, Daejeon-City (KR); Wangjoo Lee, Daejeon-City (KR)

(73) Assignee: Electronics and Telecommunications Research Institute, Daejeon-City (KR)

(21) Appl. No.: 13/126,406

(22) PCT Filed: Aug. 12, 2009
(86) PCT No.: PCT/KR2009/004492

§ 371 Date: Apr. 27, 2011

(30) Foreign Application Priority Data
Oct. 27, 2008 (KR) 1020080105478

(51) Int. Cl. H01Q 19/06; H01Q 15/08

(52) U.S. Cl. 343/753; 343/911 R

(57) ABSTRACT

Provided is a planar meta-material (100) having negative permittivity, negative permeability, and a negative refractive index through a simple structure using a general conductor and a dielectric material (130), a planar meta-material structure including a planar meta-material (100), and a lens realized by using the planar meta-material structure or an antenna system, which has high efficiency and high gain, by including the planar meta-material structure. The planar meta-material includes: a planar dielectric material (130) having a single layer structure with single permittivity or a multilayer structure having at least two permittivities; a first conductor unit (110), which is disposed on a top surface of the planar dielectric material and includes a first conductor (110a, 110b) having a loop shape; and a second conductor unit (120), which is disposed on bottom surface of the planar dielectric material and includes a second conductor (120a, 120b) having the same shape as the first conductor, wherein permittivity, permeability, and a refractive index of the planar meta-material have zero or a negative value in a predetermined frequency domain.

### TECHNICAL FIELD

The present invention relates to a meta-material having negative permittivity, negative permeability, and a negative refractive index even in a natural state, and more particularly, to a meta-material having a certain structure, a meta-material structure, and an application field using the meta-material structure.

### BACKGROUND ART

Refractive index is the square root of the product of permittivity and permeability, and the refractive index of a naturally occurring material always has a positive value. The concept of a meta-material corresponds to that of a general material, and denotes a medium that has positive, 0, or negative permittivity, negative permeability, or a negative refractive index. In other words, generally, a refractive index changes according to a frequency, and the meta-material may have a 0 or negative refractive index in a certain frequency domain.

Phenomena, such as the reversed Snell's law, the reversed Doppler effect, and the negative phase velocity, based on physical characteristics of the meta-material are well known.

Negative permittivity of a material such as plasma is known to be obtained in nature, but a method of obtaining negative permeability began to be known only after Professor Pendry disclosed a ‘Swiss roll’ or a ‘split ring resonator (SRR)’ structure in his thesis in 1999. A meta-material having a positive, 0, and negative refractive index had only been theoretically studied, and was first manufactured in 2001. It was experimentally determined that the refractive index of meta materials can be positive, 0, or negative.

Meta-materials are prepared by combining a wire structure for obtaining negative permittivity and an SRR structure for obtaining negative permeability, and such a preparation method is mainly used in developing a meta-material structure. Various meta-material structures have been suggested, and application fields for the meta-material structures are being diversely developed.

### DISCLOSURE OF INVENTION

### Technical Problem

The present invention provides a planar meta-material having negative permittivity, negative permeability, and a negative refractive index through a simple structure using a general conductor and dielectric material, and a planar meta-material structure including the meta-material.

The present invention also provides a lens realized by using a planar-metal-material structure and an antenna system including the planar meta-material structure thereby obtaining high efficiency and high gain,

### Technical Solution

According to an aspect of the present invention, there is provided a planar meta-material including: a planar dielectric material having a single layer structure with single permittivity or a multilayer structure having at least two permittivities; a first conductor unit, which is disposed on a top surface of the planar dielectric material and comprises a first conductor having a loop shape; and a second conductor unit, which is disposed on a bottom surface of the planar dielectric material and comprises a second conductor having the same shape as the first conductor, wherein the permittivity, permeability, and refractive index of the planar-meta material have values of 0-1 or a negative value in a predetermined frequency domain.

The planar dielectric material may have a rectangular planar structure, each of the first and second conductors may have a rectangular loop shape, and each of the first and second conductor units may include an internal conductor having a cross shape disposed within each of the first and second conductor units. The planar dielectric material may have a rectangular planar structure, each of the first and second conductors may have a rectangular loop shape disposed with a predetermined gap from each side of the planar dielectric material, and have a recessed portion that is recessed in a rectangular shape in the center, and a via hole may be formed on sides of the first and second conductors, which are recessed toward the center of the planar meta-material, wherein the first and second conductors may be connected through the via hole.

According to another aspect of the present invention, there is provided a planar meta-material structure, including a plurality of unit cells each composed of the planar meta-material of above, wherein the unit cells are disposed in an array form in rows and columns.

According to another aspect of the present invention, there is provided an antenna system including: a lower structure which includes a ground and a dielectric layer disposed on the ground; an antenna unit which is disposed on the lower structure and includes at least one antenna; and the planar meta-material structure of above which is disposed on the antenna unit.

The ground and the planar meta-material structure may be spaced apart from each other by a distance that satisfies a resonance condition of a cavity. When a wave proceeds in a Z-axis direction and the antenna unit includes at least two antennas, the at least two antennas may be disposed in an X-axis direction or a Y-axis direction, or in the X-axis direction and the Y-axis direction. The ground and the planar meta-material structure may be spaced apart from each other by a distance that satisfies a resonance condition of a cavity, and the antenna unit may be spaced apart from each of the lower structure and the planar meta-material structure by a predetermined distance, or may be disposed directly on the lower structure. The shape of the planar meta-material may be changed to adjust a beam width of an emitted wave.

According to another aspect of the present invention, there is provided a lens for sub-wavelength imaging, including the planar meta-material structure of above.

The planar meta-material structure as the lens may be disposed in front of and spaced apart by a predetermined distance from a source that emits waves, wherein an image may be formed on an image plane disposed in front of the planar meta-material structure.

### ADVANTAGEOUS EFFECTS

The planar meta-material according to the present invention can easily realize negative permittivity, negative permeability, and a negative refractive index. Also, since the planar meta-material has a plane shape different from a conventional meta-material, the planar meta-material can be easily manufactured by using a PCB technology.

In the antenna system including the planar meta-material structure of the present invention, the planar meta-material structure is disposed on the antenna, thereby improving efficiency, gain, and directivity of an antenna by using only one source. Accordingly, complexity of a signal feeding structure, loss of antenna supply power, and deterioration of reception sensitivity generated when a conventional antenna arrangement technique is used for a high gain may be simultaneously resolved.

Also, the planar meta-material structure of the present invention may be used as a high resolution lens having shorter resolution than a wavelength of an operating frequency the source. When a lens using such a planar meta-material structure is applied in a field such as nondestructive inspection, a higher resolution image than that obtained using a conventional lens may be obtained via a simple method.

### DESCRIPTION OF DRAWINGS

The above and other features and advantages of the present invention will become more apparent by describing in detail exemplary embodiments thereof with reference to the attached drawings in which:

FIGS. 1A and 1B are respectively a plan view and a cross-sectional view of a planar meta-material according to an embodiment of the present invention;

FIGS. 2A and 2B are respectively a plan view and a cross-sectional view of a planar-meta-material according to another embodiment of the present invention;

FIGS. 3A and 3B are graphs respectively showing electromagnetic characteristics of the planar meta-materials illustrated in FIGS. 1A and 2A;

FIG. 4 is a simulation photographic image showing a negative refractive index of a stack of planar meta-materials each having the structure of the planar meta-material of FIG. 1A;

FIGS. 5A and 5B are plan views respectively showing planar meta-material structures including the planar meta-materials of FIGS. 1A and 2A, according to embodiments of the present invention;

FIGS. 6A through 7B are cross-sectional views of antenna systems including a planar meta-material structure, according to embodiments of the present invention;

FIG. 8 is a conceptual diagram for describing that a beam width of a wave may be adjusted by changing the shape of a planar meta-material structure;

FIGS. 9A and 9B are graphs showing a resonance frequency according to a distance between a planar meta-material structure and a ground, in an antenna system including the planar metal-material structure;

FIGS. 10A and 10B are graphs showing a result of increased gain when a planar meta-material structure is used as an upper structure of an antenna;

FIGS. 11A and 11B are graphs showing radiating characteristics of an antenna viewed from an E-plane and an H-plane in an antenna system including a planar meta-material structure;

FIG. 12 is a cross-sectional view of a planar meta-material structure used as a lens; and

FIGS. 13A and 13B are graphs respectively showing image restoring characteristics when the planar meta-material structures of FIGS. 5A and 5B are used as a lens.

### BEST MODE

The present invention is about a structure of a single-layered meta-material having negative permittivity and negative permeability in a frequency band desired by a user, a method of designing and manufacturing the meta-material, and an application field of the meta-material. The meta-material of the present invention has a planar structure formed of a dielectric material and a conductor. In the present invention, the dielectric material may be formed of a single material or a complex material, and may have a single layer or multilayer structure. Also, the conductor according to the present invention may not only be a conventional electric conductor, but also may be a conductor formed of a complex material.

Hereinafter, the present invention will be described more fully with reference to the accompanying drawings, in which exemplary embodiments of the invention are shown. It will be understood that when an element is referred to as being ‘on’ or ‘below’ another element, it can be directly on the other element, or an intervening element may also be present. In the drawings, like reference numerals denote like elements, the sizes and shapes of elements are exaggerated for clarity, and irrelevant elements are omitted. Meanwhile, terminologies used in the present invention are for descriptive purposes only, and are not used to limit the scope of the invention.

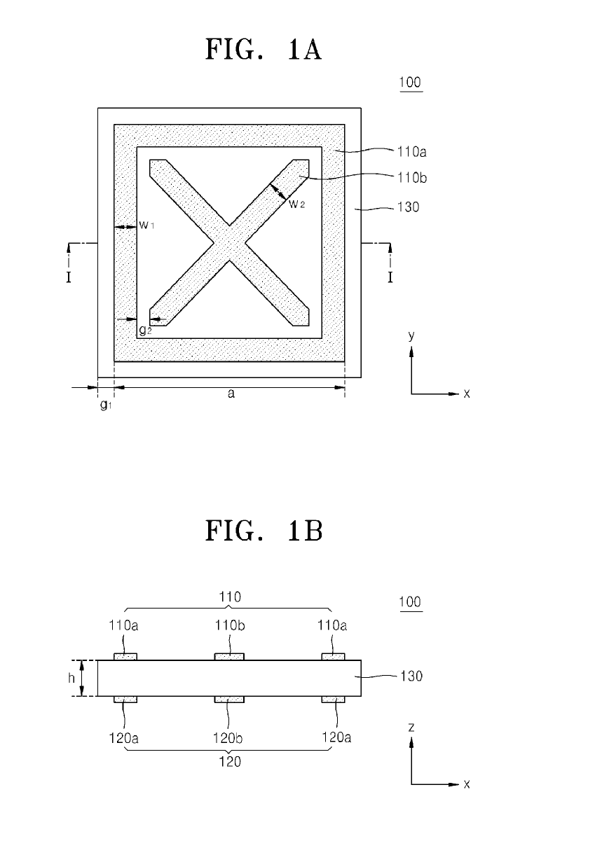

FIGS. 1A and 1B are respectively a plan view and a cross-sectional view of a planar meta-material 100 according to an embodiment of the present invention.

Referring to FIGS. 1A and 1B, the planar meta-material 100 according to the current embodiment of the present invention includes a dielectric material 130 having a planar shape, and a conductor unit disposed on top and bottom surfaces of the dielectric material 130. A shape, a size, or the like of the planar meta-material 100 formed as described above may be adjusted so that the planar meta-material 100 has negative permittivity, negative permeability, and a negative refractive index in a frequency band that is to be used. Alternatively, at least one of the permittivity and permeability may have a negative value.

In the current embodiment, the dielectric material 130 basically has a rectangular structure in a single layer having a single permittivity (ε_{T}), and has a predetermined thickness h. Alternatively, the dielectric material 130 may have a multilayer structure having different permittivities.

The conductor unit according to the current embodiment includes first and second conductor units 110 and 120 disposed on top and bottom surfaces of the dielectric material 130, respectively. The first conductor unit 110 includes a first external conductor 110a on top surface of the dielectric material 130 and a first internal conductor 110b disposed on top surface of the dielectric material 130 and disposed within the first external conductor 110a. The second conductor unit 120 includes a second external conductor 120a on bottom surface of the dielectric material 130 and a second internal conductor 120b disposed on bottom surface of the dielectric material 130 and disposed within the second external conductor 120a. Each of the first and second external conductors 110a and 120a has a rectangular shape, such as a square loop shape, and each of the first and second internal conductors 110b and 120b has a cross shape.

Each of the first and second external conductors 110a and 120a has a predetermined width W1 and are disposed to have a predetermined gap g1 from each side of the dielectric material 130. Each of the first and second internal conductors 110b and 120b has a predetermined width W2, wherein each of the four ends of the first and second internal conductors 110b and 120b has a right-angled edge like the vertex of the first and second external conductors 110a and 120a respectively and is disposed to have a predetermined gap g2 from each inner side of the first and second external conductors 110a and 120a respectively.

The first conductor unit 110 and the second conductor unit 120 of the conductor unit may be formed by stacking conductor layers on both sides of the dielectric material 130, and then etching the conductor layers in a suitable form. For example, the first conductor unit 110 and the second conductor unit 120 may be easily manufactured by using a conventional printed circuit board (PCB) technology.

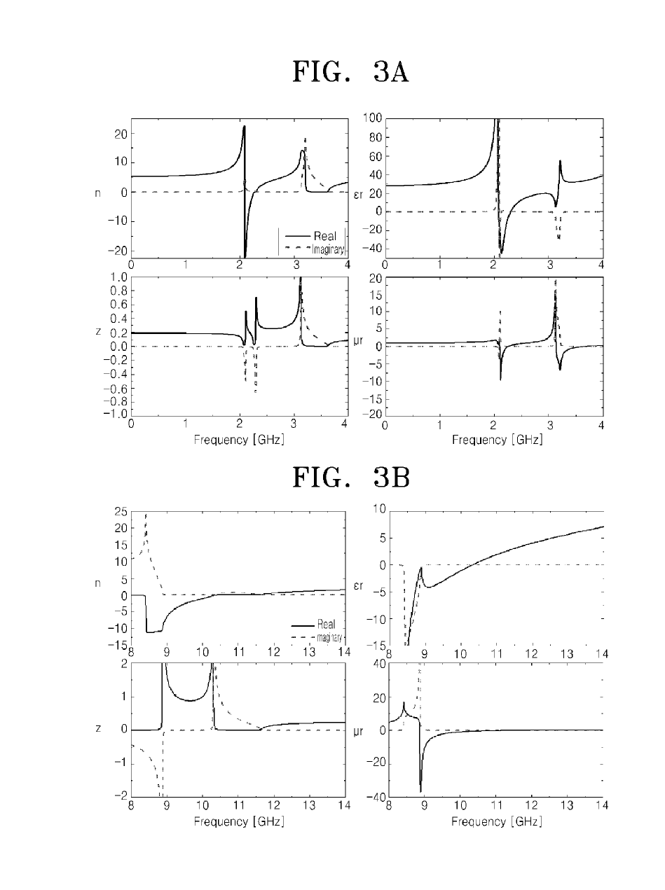

Electromagnetic characteristics of the planar meta-material 100, such as permittivity, impedance, permeability, and a refractive index, may be changed by changing shapes or sizes of the dielectric material 130 and the first and second conductor units 110 and 120 forming the planar meta-material 100. Details thereof will be described in more detail later with reference to FIGS. 3A and 3B.

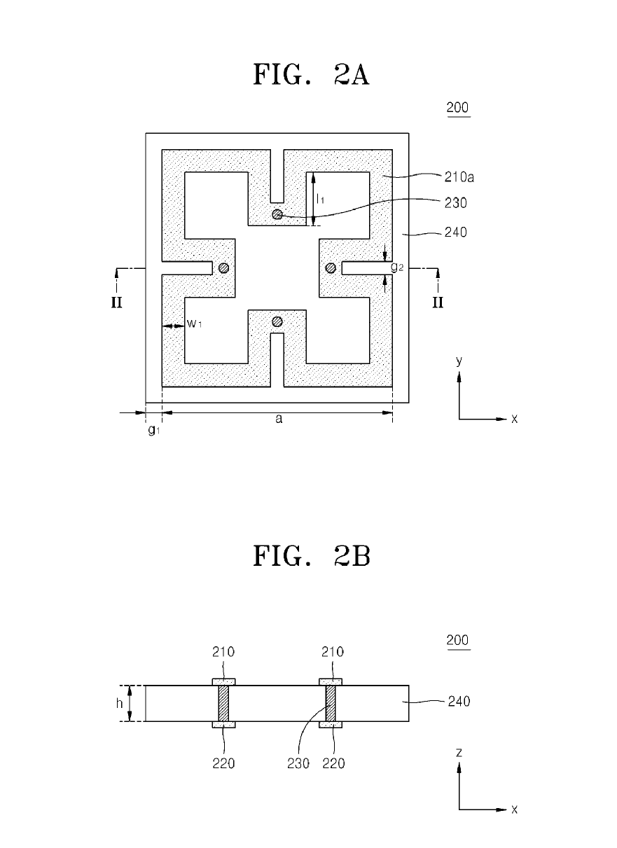

FIGS. 2A and 2B are respectively a plan view and a cross-sectional view of a planar-meta-material 200 according to another embodiment of the present invention.

Referring to FIGS. 2A and 2B, the planar meta-material 200 according to the current embodiment of the present invention also includes a dielectric material 240 having a planar shape, and first and second conductor units 210 and 220 disposed on top and bottom surfaces of the dielectric material 240, respectively. However, the shape of the first and second conductor units 210 and 220 is different from that of the first and second conductor units 110 and 120 of FIG. 1A or FIG. 1B, and the first and second conductor units 210a and 210b disposed on the top and bottom surfaces of the dielectric material 240, respectively, are connected to each other through a plurality of via holes 230.

In detail, each of the first and second conductor units 210 and 220 in the present embodiment has a square loop shape as a whole but is different from the first and second external conductors 110a and 120a in detail, and does not include an internal conductor such as the first and second internal conductors 110b and 120b of FIG. 1A or FIG. 1B. The first and second conductor units 210 and 220 do not have a simple square shape however, but have a structure wherein sides thereof have a predetermined width W1 and spaced apart from sides of the dielectric material 240 by a predetermined gap g1, and rectangular recessed portions are formed from the center of the sides towards the center of the first and second conductor units 210 and 220. Two parallel sides of each of the recessed portions have a predetermined length 11 from the inner sides to the end of the recessed portion and are disposed to have a predetermined gap g2 therebetween. Also, sides of the recessed portion facing toward the center of the first and second conductor units 210 and 220 form a square shape. Accordingly, five small squares are formed in the inner part of each of the first and second conductor units 210 and 220 due to the recessed portions.

Meanwhile, the via holes 230 are formed on the sides of the center of the recessed portions, and the first and second conductor units 210 and 220 on the top and bottom surfaces of the dielectric material 240 are electrically connected to each other through the via holes 230.

Meanwhile, electromagnetic characteristics of the planar meta-material 200 may also be changed by changing the shapes and sizes of the dielectric material 240 and the first and second conductor units 210 and 220.

FIGS. 3A and 3B are graphs respectively showing electromagnetic characteristics of the planar meta-materials illustrated in FIGS. 1A and 2A. In this regard, FIG. 3A is a graph showing the electromagnetic characteristics of the planar meta-material 100 of FIG. 1A, and FIG. 3B is a graph showing the electromagnetic characteristics of the planar meta-material 200 of FIG. 2A.

Referring to FIG. 3A, the upper left graph shows a refractive index characteristic according to frequency, of the planar meta-material 100 of FIG. 1A, and it can be seen that a refractive index, i.e. a real part of the refractive index, is negative in a frequency domain between 2.08 and 2.3 GHz. Also, it can be seen that the refractive index is 0 in a frequency domain equal to or greater than 3 GHz, and a frequency domain where the refractive index is below 1 can also be checked For reference, refractive indices of naturally occurring materials have a value equal to or greater than 1.

The upper right and lower right graphs respectively show permittivity and permeability according to frequency, of the planar meta-material 100 of FIG. 1A. It can be seen that the permittivity and permeability are negative in a frequency domain when the refractive index is negative. Consequently, it is determined that the refractive index of FIG. 3A corresponds with a mathematical definition of a refractive index.

Meanwhile, the lower left graph shows wave impedance normalized to free space impedance (≈377 Ω), and a domain where impedance is 0, i.e. a wave inhibition band, can be seen. Such a wave inhibition band corresponds to a band wherein an imaginary part of the refractive index is not 0 and simultaneously, a real part of the refractive index is not 0. The wave inhibition band corresponds to a domain wherein a frequency is equal to or greater than 3 GHz in the upper left graph.

In FIG. 3B, the refractive index, permittivity, and permeability are negative in a frequency domain between 8 and 10 GHz. Also in the impedance graph, that is, the lower left graph, a wave inhibition band, i.e. a domain where impedance is 0, corresponds to a frequency domain wherein the refractive index is less than or equal to 0 in the upper left graph. Meanwhile, by comparing FIGS. 3A and 3B, it can be seen that the planar meta-material 200 of FIG. 2A has a negative refractive index, negative permittivity, and negative permeability in a higher frequency band than the planar meta-material 100 of FIG. 1A.

As described above, electromagnetic characteristics of the planar meta-materials 100 and 200 of FIGS. 1A and 2A may be changed through shapes and structures of the dielectric materials 130 and 240 and conductor units 110, 120, 210, and 220 forming the planar meta-materials 100 and 200. For example, the electromagnetic characteristics of the planar meta-material 100 may be changed by changing at least one parameter from among the thickness h of the dielectric material 130, the width W1 of the first and second external conductors 110a and 120a, the width W2 of the first and second internal conductors 110b and 120b, the gap g1 from each side of the first and second external conductors 110a and 120a to each side of the dielectric material 130, and the gap g2 from each end of the cross of the first and second internal conductors 110b and 120b to each side of the first and second external conductors 110a and 120a. Also, the electromagnetic characteristics of the planar meta-material 200 may be changed by changing at least one parameter from among the width W1 of the first and second conductor units 210 and 220, the gap g1 from each side of the first and second conductor units 210 and 220 to each side of the dielectric material 240, the length 11 of two parallel sides of each of the recessed portions from the inner sides to the end of the recessed portion, and the gap g2 between the two parallel sides of the recessed portion. Here, changing of the electromagnetic characteristics includes changing a frequency band of a negative refractive index, negative permittivity, and negative permeability.

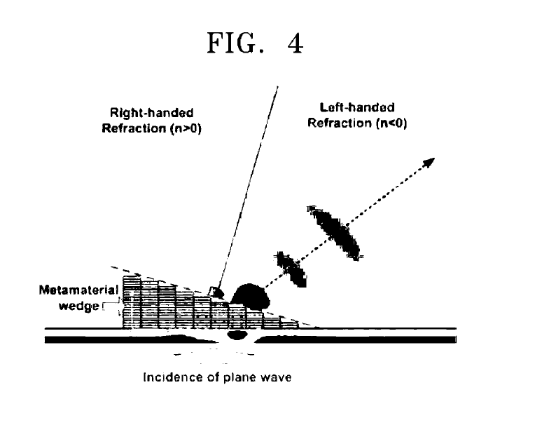

FIG. 4 is a simulation photographic image showing a negative refractive index of a stack of planar meta-materials each having the structure of the planar meta-material 100 of FIG. 1A. The planar meta-materials are stacked in a wedge or pyramid shape to have a slope, and then a plane wave is irradiated to the stacked planar meta-materials to measure a proceeding direction of the refracted wave.

Referring to FIG. 4, it is determined whether the refracted wave proceeds in a negative direction according to Snell's law via a computer simulation. When the refracted wave proceeds to the right of a solid black line, a material is a meta-material having a negative refractive index, when the electromagnetic wave refracts to the left of a solid black line, the material is a naturally occurring material having a positive refractive index, and when the electromagnetic wave refracts along the solid black line, the material is a meta-material having 0 refractive index.

As illustrated in FIG. 4, the incident plane wave is refracted to the right side of the solid black line as shown by a dotted arrow. Accordingly, the planar meta-material 100 has a negative refractive index.

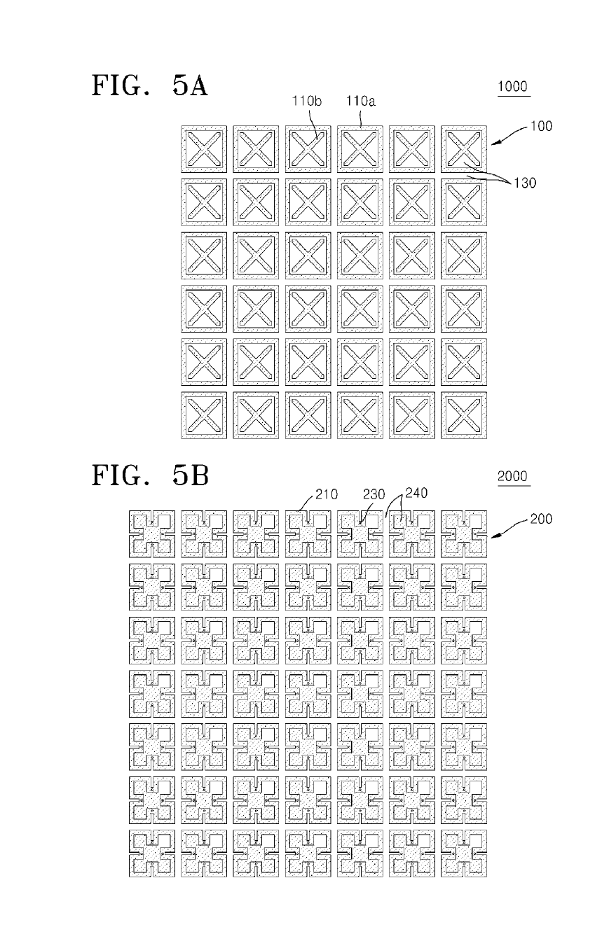

FIGS. 5A and 5B are plan views respectively showing planar meta-material structures 1000 and 2000 including the planar meta-materials 100 and 200 of FIGS. 1A and 2A, according to embodiments of the present invention.

Referring to FIGS. 5A and 5B, the planar meta-material structures 1000 and 2000 respectively use the planar meta-materials 100 and 200 of FIGS. 1A and 2A as unit cells, and have an array form wherein a plurality of such unit cells are arranged in rows and columns. In FIG. 5A, the planar meta-materials 100 are arranged in six rows and six columns, and in FIG. 5B, the planar meta-materials 200 are arranged in seven rows and seven columns.

The planar meta-material structures 1000 and 2000 may be used in various application fields. For example, the planar meta-material structures 1000 and 2000 may be used to increase the efficiency and gain of an antenna. The number of unit cells forming the planar meta-material structures 1000 and 2000 is not limited, and may be determined according to a user.

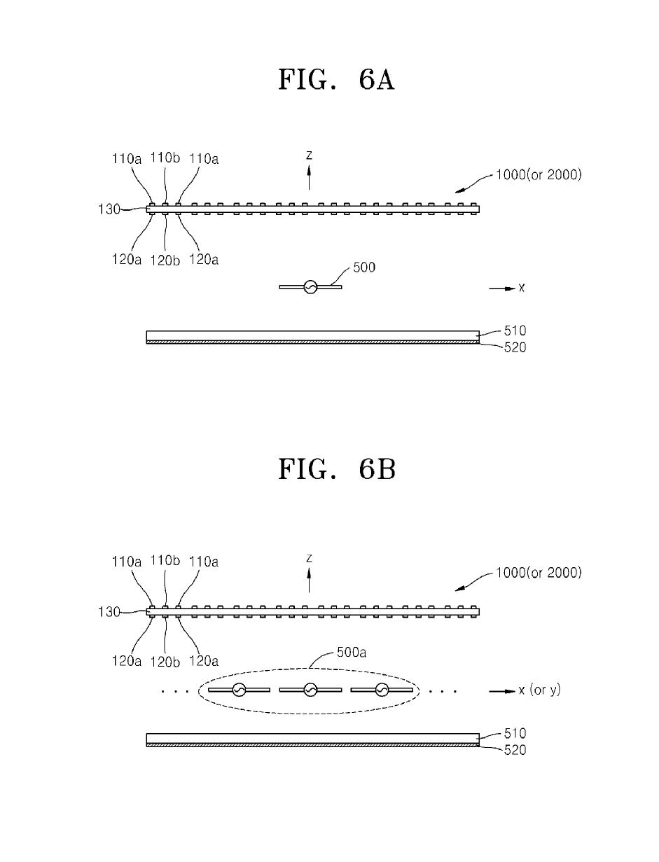

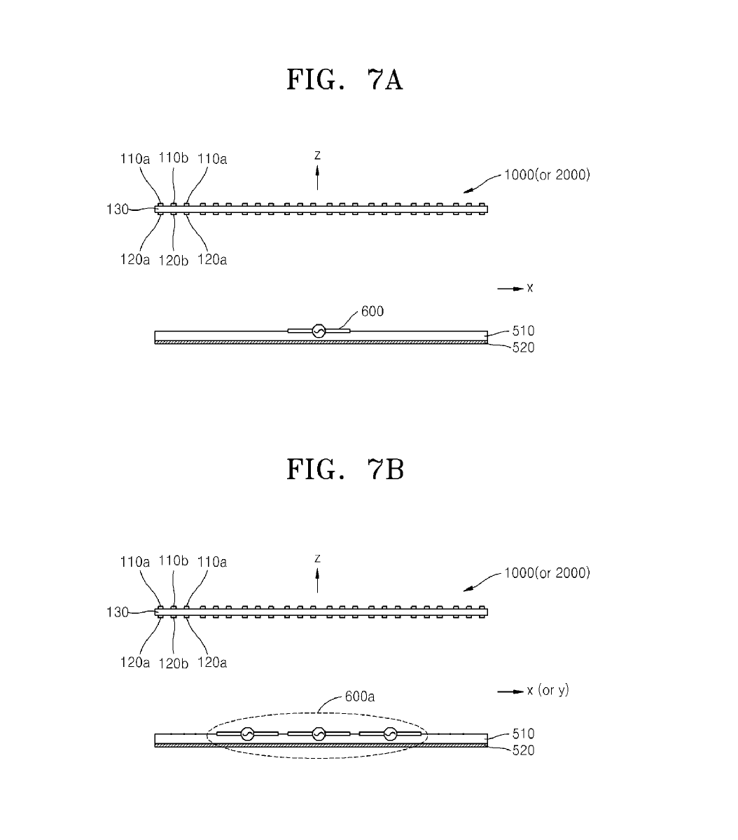

FIGS. 6A through 7B are cross-sectional views of antenna systems including the planar meta-material structure 1000 or 2000, according to embodiments of the present invention.

Referring to FIG. 6A, the antenna system according to an embodiment includes a ground 520, a dielectric layer 510 on the ground 520, an antenna 500, and the planar meta-material structure 1000 or 2000.

The planar meta-material structures 1000 and 2000 have been described with reference to FIGS. 5A and 5B, and respectively use the planar meta-materials 100 and 200 of FIGS. 1A and 2A as unit cells.

In such an antenna system, a gap between the ground 520 and the planar meta-material structure 1000 or 2000 is important. In order to increase the efficiency or gain of the antenna 500, the distance between the ground 520 and the planar meta-material structure 1000 or 2000 satisfies a resonance condition of a cavity. For reference, a minimum resonance distance of a cavity formed only of a general electric conductor is λ/2, which is a half of a wavelength, i.e, λ.

Meanwhile, the antenna 500 is not limited to a specific type, and may be any type of antenna, such as a conventional dipole antenna. Also, the number of antennas 500 is not limited, and a plurality of antennas 500a may be disposed as illustrated in FIG. 6B. When the plurality of antennas 500a are disposed, the antennas 500a may be arranged in an x-direction or a y-direction, or both an x-direction and y-direction, when a proceeding direction of a wave is a z-direction.

An antenna 600 may be disposed to have a uniform gap from the dielectric layer 510 as illustrated in FIG. 6A or 6B, but as illustrated in FIG. 7A, the antenna 600 may be disposed directly on the dielectric layer 510. Meanwhile, the antenna 600 disposed on the dielectric layer 510 may be a rectangular patch antenna, but is not limited thereto. In FIG. 7B, a plurality of antennas 600a are disposed on the dielectric layer 510.

In the antenna systems according to the current embodiments of the present invention, not only the gain or efficiency of an antenna is increased, but power efficiency and reception sensitivity of the antenna system are increased according to the increase of the gain or efficiency of the antenna. Meanwhile, high efficiency of the antennas 500 and 600 is obtained based on the planar meta-material structure 1000 or 2000 as shown in FIGS. 6A and 7A by using one feeding portion, i.e. one antenna 500 and 600, but the plurality of antennas 500a and 600a may be used as illustrated in FIGS. 6B and 7B in order to obtain higher gain or efficiency.

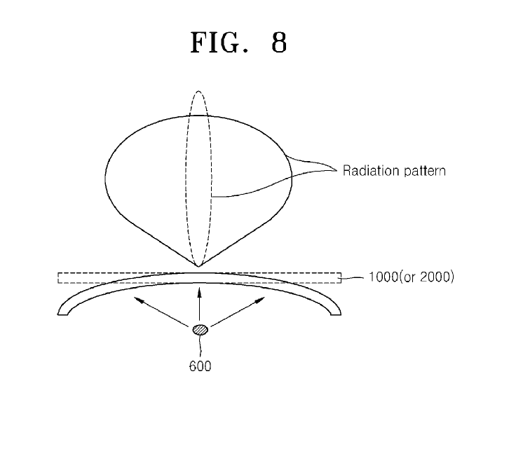

FIG. 8 is a conceptual diagram for describing that a beam width of a wave may be adjusted by changing the shape of a planar meta-material structure.

Referring to FIG. 8, a bean width of an emitted wave may be adjusted by changing the shape of the planar meta-material structure 1000 or 2000 in the antenna systems of FIGS. 6A through 7B. As shown in FIG. 8, the beam width of the emitted wave is greater with respect to the planar meta-material structure 1000 or 2000 shown in a curved solid line than with respect to the planar meta-material structure 1000 or 2000 shown in a dotted line.

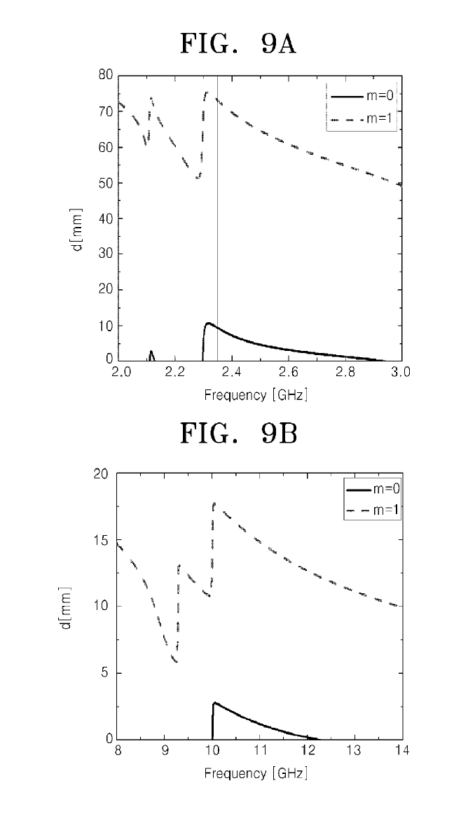

FIGS. 9A and 9B are graphs showing a resonance frequency according to a distance between the planar meta-material structures 1000 and 2000 and a ground, in the antenna systems including the planar metal-material structures 1000 and 2000.

FIG. 9A shows a theoretical resonance frequency according to a distance in a cavity having the structure of FIG. 6A or 7A, formed of the planar meta-material structure 1000 of FIG. 5A and a general conductor. When an antenna operates in a 2.3 GHz band, resonance is generated where distances between a ground and the top surface of an antenna system, i.e. the planar meta-material structure 1000, are about 10 mm and about 75 mm. Here, m=0 denotes a first resonance distance and m=1 denotes a second resonance distance, and although not illustrated, subsequent resonance distances also exist. Resonance is generated at several distances because a resonance condition satisfies integral multiplication of a wavelength.

FIG. 9B shows a resonance distance between the planar meta-material structure 2000 of FIG. 5B and a ground, and it can be seen that resonance distances are 1 mm and 14 mm at 11.5 GHz.

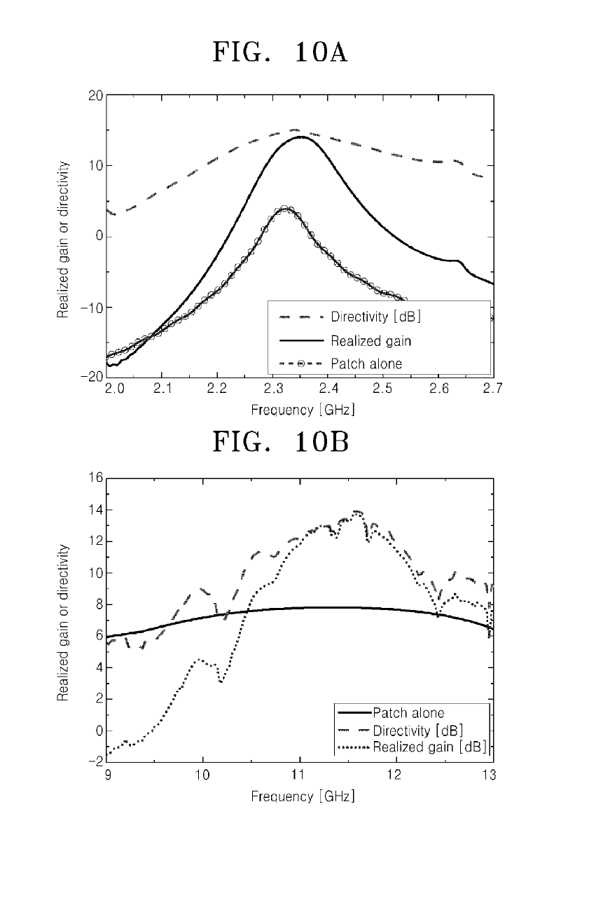

FIGS. 10A and 10B are graphs showing a result of increased gain when a planar meta-material structure is used as an upper structure of an antenna.

FIG. 10A shows a result of increased gain of an antenna when a planar meta-material structure having unit cells of the planar meta-material 100 of FIG. 1A is used as an upper structure of the antenna, in an antenna system. A rectangular patch antenna is used to feed a signal. Meanwhile, the planar meta-material structure uses 121 (11×11) planar meta-material unit cells, and has a size of about 1.9λ×1.9 λ based on an operating frequency 2.35 GHz. A gap between a ground of the antenna and the planar meta-material structure is 72 mm (about 0.6 λ).

As shown in FIG. 10A, a difference between gains when the meta-material structure is disposed on the antenna (realized gain) and when the meta-material structure is not disposed on the antenna (patch alone) is equal to or greater than about 10 dB. Considering that the gain illustrated in FIG. 10A is the realized gain instead of a general gain, 10 dB is a very large value. Here, directivity denotes a directive gain.

FIG. 10B shows a result of increased gain of an antenna when a planar meta-material structure having unit cells of the planar meta-material 200 of FIG. 2A is used as an upper structure of the antenna, in an antenna system. A rectangular patch antenna having an operating frequency of 11.5 GHz is used as the antenna. The planar meta-material structure uses 121 (11×11) planar meta-material unit cells, and has a size of about 1.9λ×1.9 λ based on the operating frequency of 11.5 GHz. A gap between a ground of the antenna and the planar meta-material structure is 14 mm (about 0.5 λ).

As illustrated in FIG. 10B, a gain of about 7 dB is increased by using the planar meta-material structure, compared to using only the rectangular patch antenna.

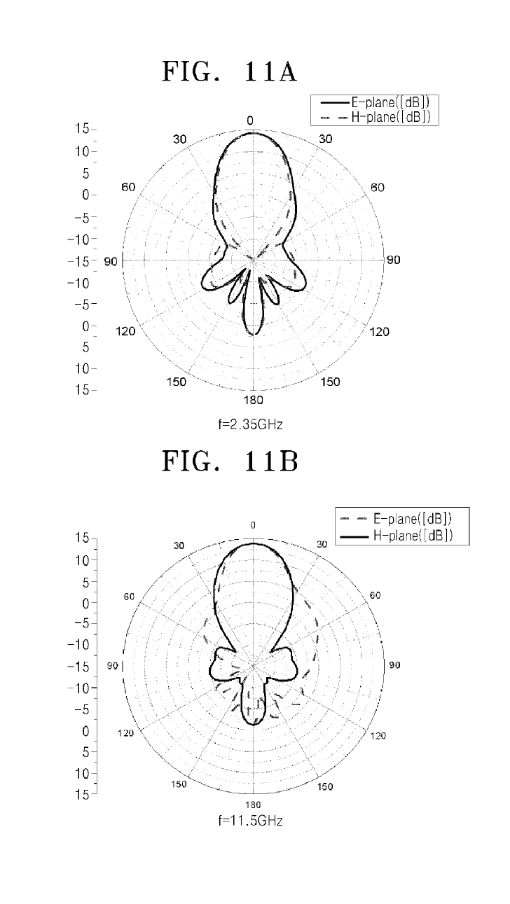

FIGS. 11A and 11B are graphs showing radiating characteristics of an antenna viewed from an E-plane and an H-plane in an antenna system including a planar meta-material structure.

The largest gains in FIGS. 11A and 11b are measured at 2.35 GHz and 11.5 GHz, respectively. It can be seen that a beam is steered in a direction perpendicular to the antenna.

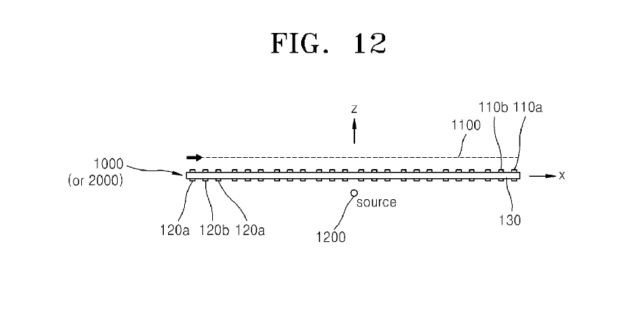

FIG. 12 is a cross-sectional view of the planar meta-material structure 1000 or 2000 used as a lens for subwavelength imaging, according to an embodiment of the present invention.

Referring to FIG. 12, the planar meta-material structure 1000 or 2000 is disposed on a source 1200, and thus is used as a high resolution lens having much shorter resolution than an operating wavelength of the source 1200. The source 1200 may be any source that emits waves, such as an actual antenna. Examples of the source 1200 include an aperture and a crack.

Electromagnetic waves from the source 1200 pass through the lens having a negative refraction characteristic, and form an image on an image plane 1100, wherein the image has much shorter wavelength resolution than a critical operating wavelength of the source 1200 in geometrical optics.

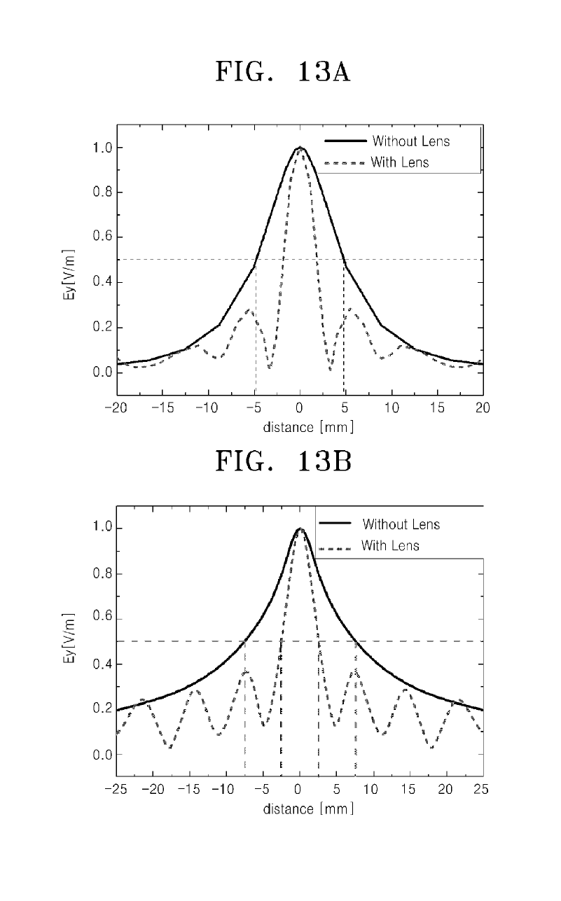

FIGS. 13A and 13B are graphs respectively showing image restoring characteristics when the planar meta-material structures 1000 and 2000 of FIGS. 5A and 5B are used as a lens.

FIGS. 13A and 13B show an actual image restoration characteristic of the planar meta-material structure via simulation, by using the planar meta-material structure as a lens as illustrated in FIG. 12.

A source used in FIGS. 13A and 13B is a dipole antenna having a width of 35 μm. The planar meta-materials 100 and 200 of FIGS. 1A and 2A are respectively used as unit cells in FIGS. 13A and 13B, and the maximum values of curves in FIGS. 13A and 13B are normalized to 1 in order to compare resolution. For convenience of description, resolution of an image is determined by a distance to be half of the maximum value from a position of the maximum values. Resolution of an image with a lens is triple the resolution of an image without a lens. In other words, examining a distance wherein intensity of an electric field on a Y-axis coordinate is reduced to half, the distance when a lens is not used is triple the distance when the planar meta-material structure is used as a lens.

The planar meta-material according to the present invention can easily realize negative permittivity, negative permeability, and a negative refractive index. Also, since the planar meta-material has a plane shape different from a conventional meta-material, the planar meta-material can be easily manufactured by using a PCB technology.

In the antenna system including the planar meta-material structure of the present invention, the planar meta-material structure is disposed on the antenna, thereby improving efficiency, gain, and directivity of an antenna by using only one source. Accordingly, complexity of a signal feeding structure, loss of antenna supply power, and deterioration of reception sensitivity generated when a conventional antenna arrangement technique is used for a high gain may be simultaneously resolved.

Also, the planar meta-material structure of the present invention may be used as a high resolution lens having shorter resolution than a wavelength of an operating frequency the source. When a lens using such a planar meta-material structure is applied in a field such as nondestructive inspection, a higher resolution image than that obtained using a conventional lens may be obtained via a simple method.

While the present invention has been particularly shown and described with reference to exemplary embodiments thereof, it will be understood by those of ordinary skill in the art that various changes in form and details may be made therein without departing from the spirit and scope of the present invention as defined by the following claims.

### Mode for Invention

### INDUSTRIAL APPLICABILITY

The present invention relates to a meta-material having negative permittivity, negative permeability, and a negative refractive index even in a natural state, and more particularly, to a meta-material having a certain structure, a meta-material structure, and an application field using the meta-material structure. The planar meta-material according to the present invention can easily realize negative permittivity, negative permeability, and a negative refractive index. Also, since the planar meta-material has a plane shape different from a conventional meta-material, the planar meta-material can be easily manufactured by using a PCB technology.

Sequence List Text

1. A planar meta-material comprising:
a planar dielectric material having a single layer structure with single permittivity or a multilayer structure having at least two permittivities;
a first conductor unit, which is disposed on a top surface of the planar dielectric material and comprises a first conductor having a loop shape; and
a second conductor unit, which is disposed on a bottom surface of the planar dielectric material and comprises a second conductor having the same shape as the first conductor,
wherein the permittivity, permeability, and refractive index of the planar-meta material have values of 0-1 or a negative value in a predetermined frequency domain.

2. The planar meta-material of claim 1, wherein the planar dielectric material has a rectangular planar structure,
each of the first and second conductors has a rectangular loop shape, and
each of the first and second conductor units comprises an internal conductor having a cross shape disposed within each of the first and second conductor units.

3. The planar meta-material of claim 2, wherein each of the first and second conductors has a square loop shape, wherein each side of the square loop has a first width and maintains a first gap from each side of the planar dielectric material,
the internal conductor has a second width, wherein each end of the cross has the same shape as each vertex of the square loop and maintains a second gap from the side of the square loop, and
the refractive index, impedance, permittivity, and permeability of the planar meta-material changes as at least one parameter from among a length of one side of the square loop, a thickness of the planar dielectric material, the first width, the first gap, the second width, and the second gap changes.

4. The planar meta-material of claim 1, wherein the planar dielectric material has a rectangular planar structure,
each of the first and second conductors has a rectangular loop shape disposed with a predetermined gap from each side of the planar dielectric material, and
has a recessed portion that is recessed in a rectangular shape in the center, and
a via hole is formed on sides of the first and second conductors, which are recessed toward the center of the planar meta-material, wherein the first and second conductors are connected through the via hole.

5. The planar meta-material of claim 4, wherein each of the first and second conductors has a square loop shape, wherein each side of the square loop has a first width and a first gap along each side of the planar dielectric material, each length of two parallel sides of the recessed portion has a first length, wherein the two parallel sides have a second gap, and
the refractive index, impedance, permittivity, and permeability of the planar meta-material changes as at least one parameter from among a length of one side of the square loop, the first width, the first gap, the second gap, and the first length changes.

6. A planar meta-material structure, comprising a plurality of unit cells each composed of the planar meta-material of claim 1, wherein the unit cells are disposed in an array form in rows and columns.

7. The planar meta-material structure of claim 6, wherein each of the unit cells is composed of the planar meta-material of claim 2 or 4.

8. An antenna system comprising:
a lower structure which comprises a ground and a dielectric layer disposed on the ground;
an antenna unit which is disposed on the lower structure and comprises at least one antenna; and
the planar meta-material structure of claim 6 which is disposed on the antenna unit.

9. The antenna system of claim 8, wherein the ground and the planar meta-material structure are spaced apart from each other by a distance that satisfies a resonance condition of a cavity.

10. The antenna system of claim 8, wherein, when a wave proceeds in a Z-axis direction and the antenna unit comprises at least two antennas, the at least two antennas are disposed in an X-axis direction or a Y-axis direction, or in the X-axis direction and the Y-axis direction.

11. The antenna system of claim 8, wherein the ground and the planar meta-material structure are spaced apart from each other by a distance that satisfies a resonance condition of a cavity, and
the antenna unit is spaced apart from each of the lower structure and the planar meta-material structure by a predetermined distance, or is disposed directly on the lower structure.

12. The antenna system of claim 8, wherein the shape of the planar meta-material is changed to adjust a beam width of an emitted wave.

13. The antenna system of claim 8, wherein the planar meta-material structure comprises unit cells each composed of the planar meta-material of claim 2 or 4.

14. A lens for subwavelength imaging, comprising the planar meta-material structure of claim 6.

15. The lens of claim 14, wherein the planar meta-material structure as the lens is disposed in front of and spaced apart by a predetermined distance from a source that emits waves, wherein an image is formed on an image plane disposed in front of the planar meta-material structure.

16. The lens of claim 14, wherein the planar meta-material structure comprises unit cells each composed of the planar meta-material of claim 2 or 4.
